(19) United States
(12) Patent Application Publication
(10) Pub. No.: US 2012/0025513 A1
(43) Pub. Date: Feb. 2, 2012

(54) DEVICE FOR HOLDING A FILLABLE FORM

(76) Inventor: Daniel S. Woods, Tempe, AZ (US)

(21) Appl. No.: 12/847,168

(22) Filed: Jul. 30, 2010

(51) Int. Cl. B42D 17/00

(52) U.S. Cl. 281/45

(57) ABSTRACT

A device for holding a fillable form includes a writing tray adapted for placement of the fillable form, the writing tray having walls defining a perimeter of a planar surface of the writing tray. A card holder is formed in at least one of the walls. The card holder includes a groove extending inwardly from one of the walls into a body of the writing tray. The groove is configured to hold an edge portion of an identification card in a press fit engagement with the remainder of the identification card being located outside of the groove. An edge ridge is formed along at least one of the walls and extends above the planar surface of the writing tray. The edge ridge facilitates retention of the fillable form.

### TECHNICAL FIELD OF THE INVENTION

The present invention relates to the field of portable writing boards. More specifically, the present invention relates to a portable writing board for holding a fillable form as the form is being filled out by, for example, a law enforcement officer.

### BACKGROUND OF THE INVENTION

A first responder is a member of an emergency service who is the first to arrive on the scene of a conflict, accident, or emergency. A first responder may be a law enforcement officer, fireman, an emergency medical technician, and so forth. Typically when a first responder arrives at the scene of conflict, accident, emergency, and so forth, the first responder may fill out a form with basic information identifying the individual or individuals present at the scene. For example, a law enforcement officer may stop and question one or more subjects (known as a field interview) when the officer has reasonable suspicion that the subject or subjects may have committed, may be committing, or may be about to commit a crime; when the officer believes the subject may be a hazard; and/or when the officer believes that an interview may have a preventive effect. Under such circumstances, a law enforcement officer will typically complete a fillable form, known as a field interview card, for each subject questioned.

A typical field interview card has fillable sections for location and/or circumstances calling for the field interview, residence information, vehicular information, subject's appearance such as gender, race, weight, height, eye color, hair color, build, hair length, facial hair, complexion, attire, marks, tattoos, and so forth. Information from the hand-written field interview cards may eventually be entered into a computer system. Alternatively, the field interview cards may be submitted for review by a supervisor, detective, a criminal investigations division, and so forth. Therefore, it is crucial that the hand-written information be legible and easily read and understood by others.

A law enforcement officer may fill out an individual field interview card for multiple subjects. Thus, the officer may have a stack of field interview cards, may be required to question multiple subjects, may have to copy information from multiple drivers' licenses, and so forth. Under such circumstances, the multiple cards can become awkward to manipulate and hold. In addition, the stack of field interview cards may not be sufficiently rigid to write on while standing at the scene.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective view of a device for holding a fillable form in accordance with an embodiment of the present invention;

FIG. 2 shows a top view of the device with a fillable form placed on a writing tray of the device;

FIG. 3 shows an edge view of a lower wall of the device of FIG. 1;

FIG. 4 shows an edge view of an upper wall of the device of FIG. 1;

FIG. 5 shows an edge view of a side wall of the device of FIG. 1;

FIG. 6 shows a bottom view of the device;

FIG. 7 shows an enlarged sectional side view of a portion of the device along section lines 7-7 of FIG. 6

FIG. 8 shows a perspective view of the device being used by a right-handed individual; and

FIG. 9 shows a perspective view of the device being used by a left-handed individual.

### DETAILED DESCRIPTION

Embodiments of the invention entail a device in the form of a writing board that may be used to hold one or more fillable forms and provide a rigid support upon which a user may fill out the forms. The writing board is particularly suitable for situations in which one is not assured of finding a good writing surface, where the individual may need to fill out multiple forms, and/or where the individual may need to refer to additional documentation such as drivers' licenses, identification cards, insurance cards, and so forth. In an embodiment, the device may be used by a law enforcement officer who is filling out field interview cards while conducting field interviews of one or more subjects. The device is suitable for either right-handed or left-handed use, can support one or more identification cards, and can readily fit in an officer's breast pocket for easy access.

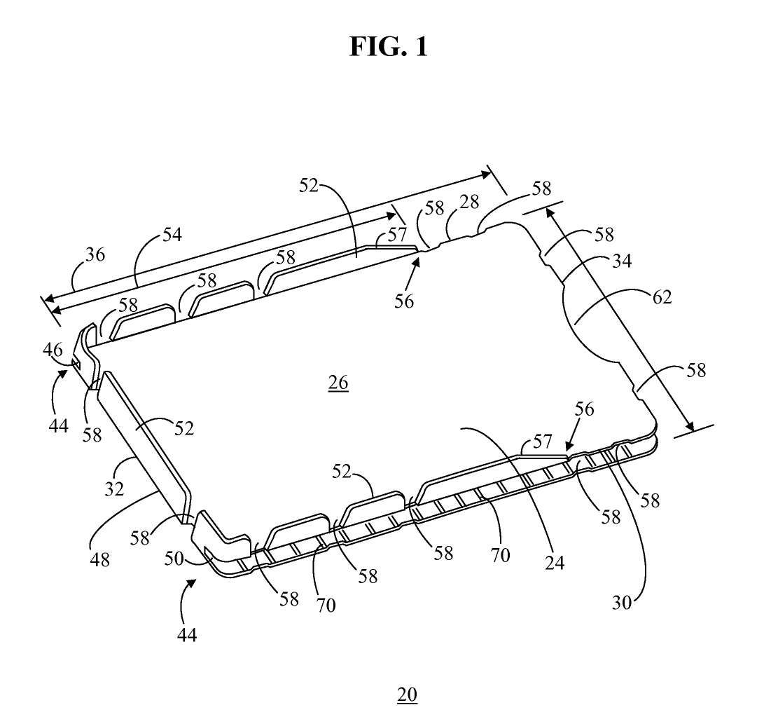

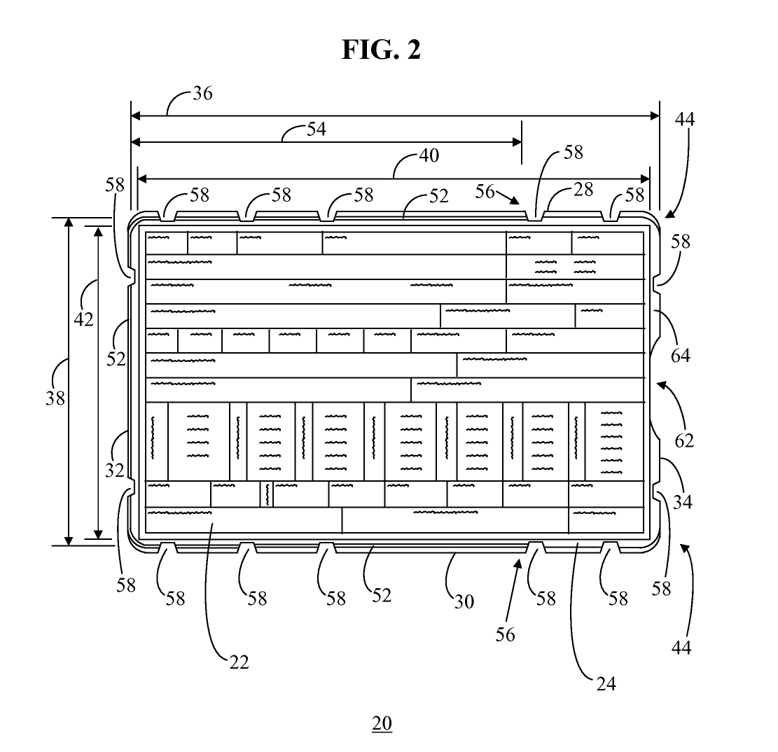

Referring to FIGS. 1 and 2, FIG. 1 shows a perspective view of a device 20 for holding a fillable form in accordance with an embodiment of the present invention, and FIG. 2 shows a top view of device 20 with a fillable form 22 placed on a writing tray 24 of device 20. Device 20, referred to hereinafter as a writing board 20, can be used by an individual to rigidly support a stack of fillable forms 22, while the individual writes on the topmost form 22 with the other hand.

In an embodiment, writing board 20 is sized to accommodate fillable form 22, known as a field interview card, used by law enforcement officers. Accordingly, fillable form 22 will be referred to hereinafter as a field interview card 22. Law enforcement jurisdictions typically use field interview card 22 that is approximately three inches by five inches so that it fits into a law enforcement officer's breast pocket and can be readily accessed. Field interview card 22 includes a number of sections that are filled out with information pertinent to each subject being questioned. A law enforcement officer typically carries a stack of field interview cards 22 so that one card can be filled out for each subject questioned. Writing board 20 readily accommodates a stack of field interview cards 22, provides a rigid surface for writing, can temporarily retain an identification card when transferring information from the identification card to the field interview card, and writing board 20 fits into a law enforcement officer's breast pocket for easy access. Although writing board 20 is discussed in connection for use with field interview cards 22, writing board 20 can be readily adapted to hold other fillable forms 22 of various sizes and shapes, such as citations, traffic violation tickets, accident reports, and the like.

Writing board 20 includes a writing tray 24 having a planar surface 26 adapted for placement of field interview card 22. Walls, referred to herein as an upper wall 28, a lower wall 30 spaced apart from upper wall 28, a first side wall 32, and a second side wall 34 spaced apart from first side wall 32, collectively define a perimeter of planar surface 26. In an embodiment, upper and lower walls 28 and 30, respectively, exhibit a length 36 and first and second side walls 32 and 34 exhibit a width 38. In an embodiment, length 36 of upper and lower walls 28 and 30, respectively, may be approximately equivalent to or slightly longer than a length 40 of field interview card 22. Similarly, width 38 of first and second side walls 32 and 34 may be approximately equivalent to or slightly wider than a width 42 of field interview card 22. Thus, field interview card 22 fits on planar surface 26 of writing tray 24 but is limited in its ability to slide about on planar surface 26.

A card holder 44 is formed in at least one of walls 28, 30, 32, and 34. In an exemplary embodiment, card holder 44 includes a first groove 46 extending inwardly from upper wall 28 into a body 48 of writing tray 24. Additionally, card holder 44 includes a second groove 50 extending inwardly from lower wall 30 into body 48 of writing tray 24. First and second grooves 46 and 50, respectively, are configured to hold an edge portion of an identification card (discussed below) in a press fit engagement. That is, grooves 46 and 50 are relatively narrow so that the edge portion of the identification card fits tight enough to hold the identification card in place while the remainder of the identification card is located outside of grooves 46 and 50. Thus, information on the identification card is visible to the officer. Although writing board 20 is shown with both first and second grooves 46 and 50 of card holder 44 formed in respective upper and lower walls 28 and 30, it should be understood that in alternative embodiments, card holder 44 may only include a single groove in one of upper and lower walls 28 and 30, or in first side wall 32.

Writing board 20 further comprises an edge ridge 52 formed along at least one of walls 28, 30, 32, and 34 and extending above planar surface 26 of writing tray 24. In an embodiment, edge ridge 52 is formed along upper wall 28, first side wall 32, and lower wall 30, and edge ridge 52 is absent along second side wall 34. In a further embodiment, edge ridge 52 extends a distance 54 along each of upper and lower walls 28 and 30 that is less than length 36 of upper and lower walls 28 and 30 such that edge ridge 52 is discontinued at an intermediate location 56 along each of upper and lower walls 28 and 30. Edge ridge 52 may optionally include a downwardly tapered region 57 ending at intermediate location 56. Although writing board 20 is shown with edge ridge 52 formed along three walls 28, 32, and 30, in alternative embodiments, edge ridge 52 may only be formed on a single wall (e.g., lower wall 30) or on two walls (e.g., lower wall 30 and first side wall 32, lower wall 30 and upper wall 28, and so forth).

Edge ridge 52 facilitates the retention of field interview card 22 on writing tray 24 so that card 22 is less likely to slide off of writing tray 24. In addition, the discontinuation of edge ridge 52 on lower wall 30 and the absence of edge ridge 52 allows for comfortable placement of the user's hand while the user writes on field interview card 22. Writing board 20 is adapted for use by either right-handed or left-handed users. Accordingly, edge ridge 52 is symmetrical on upper and lower walls 28 and 30, so that a left-handed user can simply reorient writing board 20 for his or her comfort. When used by a left-handed writer, writing board 20 can be flipped so that upper wall 28 becomes a lower wall, and second side wall 34 faces leftward. Accordingly, the absence of edge ridge 52 on second side wall and the discontinuation of edge ridge 52 on upper wall 28 allows for comfortable placement of a left-handed user's hand.

In an embodiment, writing board 20 further includes at least one notch 58 formed in at least one of walls 28, 30, 32, and 34 and extending into writing tray 24. In the illustrated embodiment, writing board 20 includes multiple notches 58, some of which extend through edge ridge 52 and into upper wall 28, lower wall 30, first side wall 32, and second side wall 34. In some instances, an officer may wish to secure multiple field interview cards 22 to writing tray 24 without excessively covering fillable sections of a top one in the stack of field interview cards 22. Notches 58 are configured to accommodate placement of a resilient band 60 (shown in FIG. 7), sometimes referred to as a rubber band, surrounding at least a portion of writing tray 24 to retain field interview cards 22 on writing tray 24. The presence of multiple notches 58 allows a user to place and/or relocate resilient band 60 in a desired position in order to fill out field interview cards 22. It should be understood that in alternative embodiments, writing board 20 can include any number of notches 58 positioned in various locations on writing board 20. In still other embodiments, writing board 20 need not include any notches 58.

Writing board 20 may further include a concave indentation 62 formed in second side wall 34 and extending into writing tray 24 such that a portion of concave indentation 62 underlies field interview cards 22 when one or more field interview cards 22 are placed on planar surface 26 of writing tray 24. Again, writing tray 24 can accommodate a stack of field interview cards 22. Concave indentation 62 facilitates removal of one of cards 22 from the top of the stack of cards 22 by pinching the stack of cards between user's thumb and index finger at concave indentation 62 and using the thumb to slide the top card 22 from the stack.

It should be recalled that in an embodiment length 36 of upper and lower walls 28 and 30 is slightly longer than length 40 of field interview cards 22. For example, length 36 may be approximately one eighth inch longer than length 40. Thus, a small portion 64 (best seen in FIG. 2) of planar surface 24 near concave indentation 62 formed in second side wall 34 is not covered by the stack of field interview cards 22. In use, an individual may slide the completed field interview card 22 from the top of the stack of cards 22, and subsequently, catch it on portion 64 of planar surface 24 to slide the completed card 22 to the bottom of the stack of cards 22 thus exposing another field interview card 22 for use.

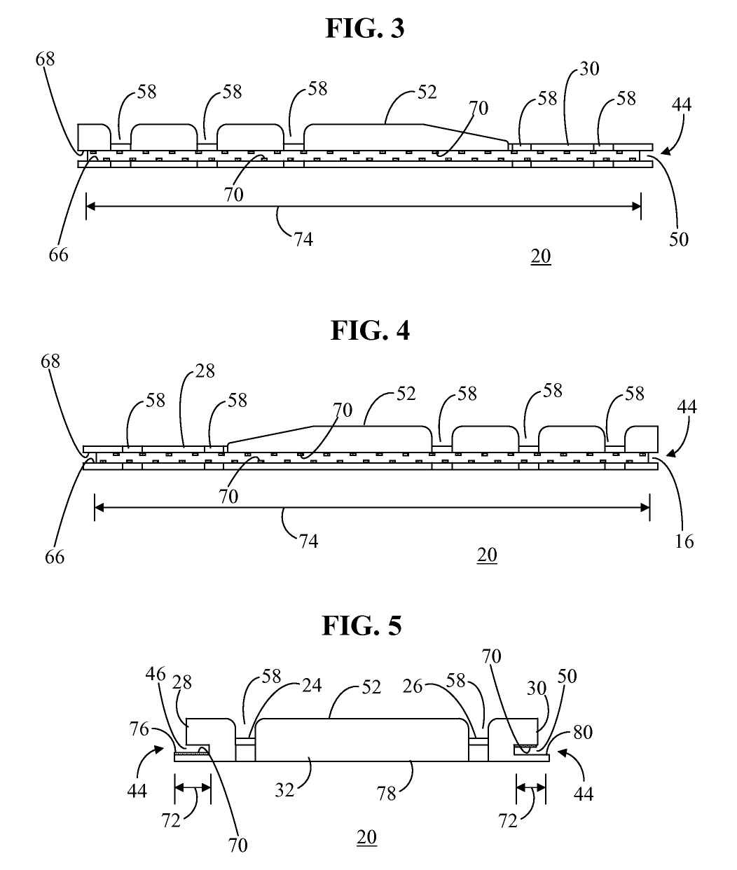

Referring now to FIGS. 3-5 in connection with FIG. 1, FIG. 3 shows an edge view of lower wall 30 of writing board 20. FIG. 4 shows an edge view of upper wall 28 of writing board 20, and FIG. 5 shows an edge view of first side wall 32 of writing board 20. It should be recalled that first and second grooves 46 and 50, respectively, of card holder 44 are configured to hold the edge portion of an identification card in press fit engagement. First groove 46 has first and second facing walls 66 and 68, respectively. Similarly, second groove 50 has first and second facing walls 66 and 68, respectively.

Elongated projections 70 are formed on first and second facing walls 66 and 68 of each of first and second grooves 46 and 50. Elongated projections 70 extend into respective first and second grooves 46 and 50. A length 72 of each of elongated projections 70, corresponding to the depth of grooves 46 and 50, is oriented approximately perpendicular to a length 74 of each of first and second grooves 46 and 50. In an embodiment, elongated projections 70 may be spaced along first and second facing walls 66 and 68, respectively, so that they are alternately displaced along facing walls 66 and 68 (best seen in FIGS. 3 and 4). In other words, elongated projections 70 are displaced such that they do not directly oppose one another on facing walls 66 and 68.

The presence of both first and second grooves 46 and 50 enable placement of an identification card in either of upper and/or lower walls 28 and 30. This enables right-handed and left-handed use. In addition, elongated projections 70 form narrower regions in each of first and second grooves 46 and 50 relative to the surrounding portions of grooves 46 and 50 to enable a tighter fit between card holder 44 and an identification card (discussed below). This tighter fit created by the presence of elongated projections 70 additionally enables placement of multiple identifications concurrently in both of first and second grooves 46 and 50, respectively.

As best seen in FIG. 5, card holder 44 may further include a first support member 76 extending from upper wall 28 and oriented substantially parallel to planar surface 26 of writing tray 24. First support member 76 is located between first groove 46 and a back surface 78 of writing tray 24, wherein back surface 78 is in opposing relationship with planar surface 26. Similarly, card holder 44 may include a second support member 80 extending from lower wall 30 and oriented substantially parallel to planar surface 26 of writing tray 24. Second support member 80 is located between second groove 50 and back surface 78 of writing tray 24.

First and second support members 76 and 80 extending from respective upper and lower walls 28 and 30 facilitate the quick placement of an identification card into either respective first and second grooves 46 and 50. Support members 76 and 80 facilitate quick placement because an officer can more readily locate either of first groove 46 or second groove 50 when he or she contacts either first support member 76 or second support member 80 with the identification card. Additionally, support members 76 and 80 can provide at least some support to the back side of the identification card to more securely hold it in place.

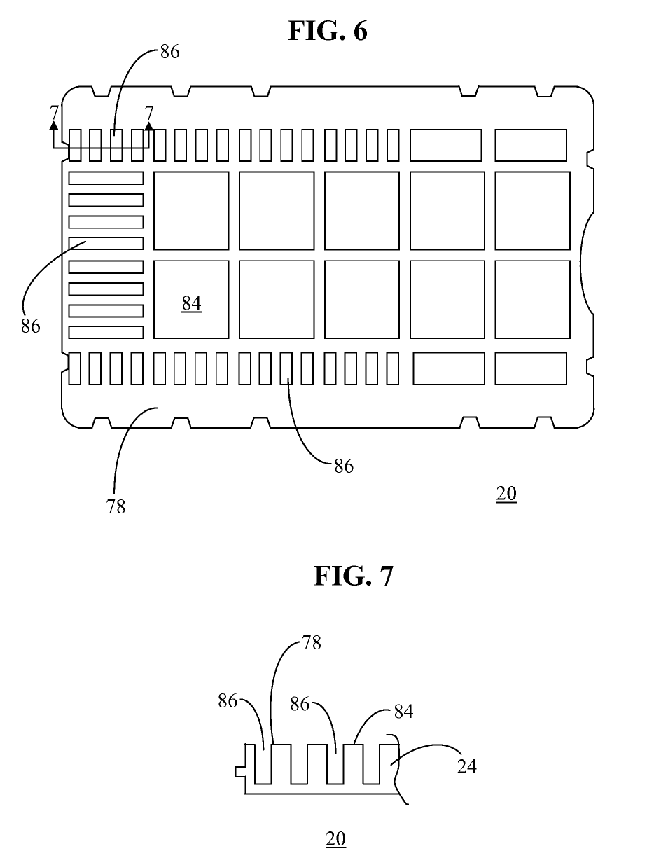

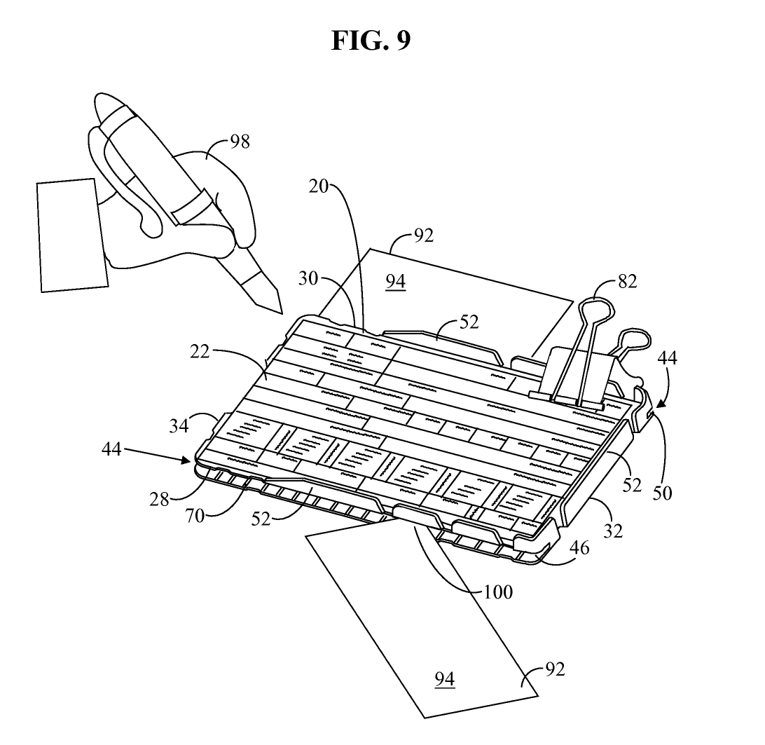

Referring to FIGS. 6 and 7, FIG. 6 shows a bottom view of writing board 20, and FIG. 7 shows an enlarged sectional side view of a portion writing board 20 along section lines 7-7 of FIG. 6. In some instances, an officer may wish to secure multiple field interview cards 22 to writing tray 24 without excessively covering fillable sections of a top one in the stack of field interview cards 22. In lieu of securing field interview cards 22 using resilient band 60, an officer may instead secure field interview cards 22 to writing board using a conventional binder clip 82 (shown in FIG. 9). Accordingly, in some embodiments back side 78 of writing board 20 may include an irregular surface 84. By way of example, irregular surface 84 may include indentations 86 that are formed during manufacturing through a molding process and/or a machining process.

The inclusion of irregular surface 84 facilitates non-sliding engagement of binder clip 82 to writing tray 24. As such, a user can place and/or relocate binder clip 82 in a desired position in order to fill out field interview cards 22. Although irregular surface 84 is formed during fabrication by creating indentations 86 in back side 78 of writing tray 24, those skilled in the art will recognize that irregular surface 84 may be formed in back side 78 by roughening back side 78 or by forming any of a variety of shapes, sizes, and locations of indentations 86 or raised bumps.

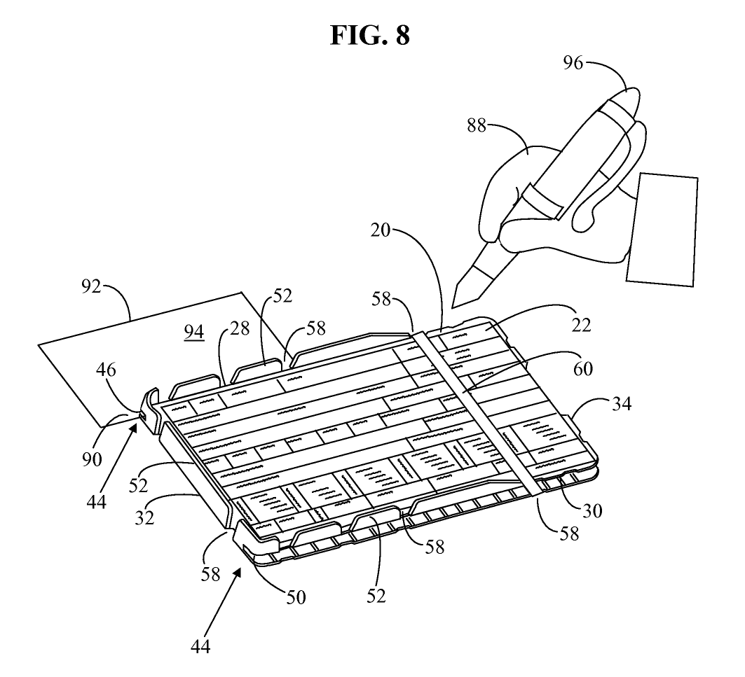

FIG. 8 shows a perspective view of writing board 20 being used by a right-handed individual 88. As shown, one or more field interview cards 22 is loaded onto writing tray 24. Edge ridge 52 formed along upper wall 28, first side wall 32, and lower wall 30 facilitates proper placement of cards 22 on writing tray 24 and resilient band 60 secures field interview cards 22 in place. An edge portion 90 of an identification card 92 is held in first groove 46 of card holder 44. Accordingly, a remaining portion 94 of identification card 92 is located outside of first groove 46. Thus, right-handed individual 88, using a pen 96 or pencil, can readily copy information from identification card 92 onto pertinent sections of field interview card 22. Although not shown for visibility, right-handed individual 88 may optionally and comfortably lay a portion of his or her hand on writing tray 24 near second side wall 34 due to the absence of edge ridge 52 along second side wall 34. Individual 88 can additionally move resilient band 60 to various notches 58, horizontally, vertically, or diagonally, to reveal sections of the underlying field interview card 22 when filling it out.

FIG. 9 shows a perspective view of writing board 20 being used by a left-handed individual 98. As shown, writing board 20 has been flipped to accommodate left-handed individual so that second side wall 34 faces leftward and first side wall 32 faces rightward. In addition, upper wall 28 is now positioned as a lower wall, and lower wall 30 is now positioned as an upper wall. Edge ridge 52 formed along upper wall 28, first side wall 32, and lower wall 30 facilitates proper placement of cards 22 on writing tray 24 and binder clip 82 secures field interview cards 22 in place.

Since card holder 44 includes both first and second grooves 46 and 50, identification cards 92 (of which two are shown) can be placed in either of first and second grooves 46 and 50. Note that elongated indentations 70 provide sufficient pressure so that only a corner edge portion 100 one of identification cards 92 is engaged with the bottom most groove, i.e., first groove 66, in this flipped configuration. Although, only a single identification card is shown in each of first and second grooves 46 and 50, it should be understood that each groove 46 and 50 can hold more than one identification card 92. Thus, card holder 44 is adapted to retain multiple identification cards 92 in multiple positions and locations so that the officer has easy access to identification cards 92 when interviewing a number of subjects.

Although not shown for visibility, left-handed individual 98 may optionally and comfortably lay a portion of his or her hand on writing tray 24 near second side wall 34 due to the absence of edge ridge 52 along second side wall 34. Individual 98 can additionally move binder clip 82 to various locations, horizontally or vertically, to reveal sections of the underlying field interview card 22 when filling it out.

In summary, the present invention teaches a device, in the form of a writing board, that may be used to hold one or more fillable forms. The device includes a rigid writing tray that is partially surrounded by an edge ridge for facilitating proper placement of the fillable forms. The fillable forms may be secured onto the writing tray using, for example, a resilient band or a binder clip. The device further includes a card holder adapted to retain one or more drivers' licenses, identification cards, insurance cards, and so forth. The device is especially suitable for use by a law enforcement officer who is filling out field interview cards while conducting a field interview of one or more subjects. Additionally, the device is configured to accommodate either right-handed individuals or left-handed individuals.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A device for holding a fillable form comprising:
a writing tray having a planar surface adapted for placement of said finable form, said writing tray having walls defining a perimeter of said planar surface; and
a card holder formed in one of said walls, said card holder including a groove extending inwardly from said one of said walls into a body of said writing tray, said groove being configured to hold an edge portion of an identification card in a press fit engagement with a remaining portion of said identification card being located outside of said groove.

2. A device as claimed in claim 1 further comprising an edge ridge formed along at least one of said walls and extending above said planar surface.

3. A device as claimed in claim 2 wherein said walls include spaced apart upper and lower walls and spaced apart first and second side walls, said edge ridge is formed along said upper wall, said first side wall, and said lower wall, and said edge ridge is absent along said second side wall.

4. A device as claimed in claim 2 wherein said walls include a lower wall, said lower wall exhibiting a length, said edge ridge extends a distance along said lower wall, said distance being less than said length such that said edge ridge is discontinued at an intermediate location along said lower wall.

5. A device as claimed in claim 4 wherein said walls further include an upper wall spaced apart from said lower wall, said edge ridge is a first edge ridge, and said device further comprises a second edge ridge formed along said upper wall and extending above said planar surface, said second edge ridge extending said distance along said upper wall and being discontinued at a second intermediate location along said upper wall.

6. A device as claimed in claim 1 further comprising a notch formed in at least one of said walls and extending into said writing tray for accommodating placement of a resilient band surrounding at least a portion of said writing tray to retain said fillable form on said writing tray.

7. A device as claimed in claim 1 wherein said planar surface is a front side of said writing tray, and said writing tray has a back side opposing said front side, said back side having an irregular surface for facilitating non-sliding engagement of a binder clip to said writing tray, said binder clip being configured to retain said fillable form on said writing tray.

8. A device as claimed in claim 1 wherein said walls include a side wall, and said device further comprises a concave indentation formed in said side wall and extending into said writing tray such that a portion of said concave indentation underlies said fillable form when said fillable form is placed on said writing tray.

9. A device as claimed in claim 1 wherein said walls include spaced apart upper and lower walls, and a first width of said planar surface between said upper and lower walls is configured to be approximately equivalent to a second width of said fillable form.

10. A device as claimed in claim 9 wherein said walls further include spaced apart first and second side walls, and a first length of said planar surface between said first and second side walls is configured to be greater than a second length of said fillable form.

11. A device as claimed in claim 1 wherein said one of said walls an upper wall, said walls include a lower wall spaced apart from said upper wall, said groove is a first groove, and said card holder further includes a second groove formed in said lower wall, said second groove being configured to hold said identification card in said press fit engagement.

12. A device as claimed in claim 1 wherein said card holder further includes elongated projections formed on first and second facing walls of said groove, said elongated projections extending into said groove and being oriented approximately perpendicular to a length of said groove.

13. A device as claimed in claim 1 wherein said card holder further includes a support member extending from said one of said walls and oriented substantially parallel to said writing tray, said support member being located between said groove and a back surface of said writing tray, said back surface opposing said planar surface.

14. A device for holding a fillable form comprising:
a writing tray having a planar surface adapted for placement of said fillable form, said writing tray having spaced apart upper and lower walls and spaced apart first and second side walls defining a perimeter of said planar surface;
a card holder formed in at least one wall of a group consisting of said upper and lower walls and said first and second side walls, said card holder including a groove extending inwardly from said at least one wall into a body of said tray, said groove being configured to hold an edge portion of an identification card in a press fit engagement with a remaining portion of said identification card being located outside of said groove, and;
an edge ridge formed along said upper wall, said first side wall, and said lower wall, said edge ridge extending above said planar surface, said edge ridge being absent along said second side wall, wherein each of said upper and lower walls exhibits a length, said edge ridge extends a distance along said each of said upper and lower walls, said distance being less than said length such that said edge ridge is discontinued at an intermediate location along said each of said upper and lower walls.

15. A device as claimed in claim 14 further comprising a concave indentation formed in said second side wall and extending into said writing tray such that a portion of said concave indentation underlies said fillable form when said fillable form is placed on said writing tray.

16. A device as claimed in claim 14 wherein:
a first width of said planar surface between said upper and lower walls is configured to be approximately equivalent to a second width of said fillable form; and
a first length of said planar surface between said first and second side walls is configured to be greater than a second length of said fillable form.

17. A device for holding a fillable form comprising:
a writing tray having a planar surface adapted for placement of said fillable form, said writing tray having spaced apart upper and lower walls and spaced apart first and second side walls defining a perimeter of said planar surface;
a card holder formed in at least one wall of a group consisting of said upper and lower walls and said first and second side walls, said card holder including:
a groove extending inwardly from said one of said side walls into a body of said tray, said groove having first and second facing walls; and
elongated projections formed on said first and second facing walls and extending into said groove, said elongated projections being oriented approximately perpendicular to a length of said groove, wherein said groove and said elongated projections function cooperatively to hold an edge portion of an identification card in a press fit engagement with a remaining portion of said identification card being located outside of said groove; and
an edge ridge formed along said upper wall, said first side wall, and said lower wall, said edge ridge extending above said planar surface, and said edge ridge being absent along said second side wall.

18. A device as claimed in claim 17 wherein said one wall is said upper wall, said groove is a first groove, said elongated projections are first elongated projections, and said card holder further includes:
a second groove formed in said lower wall, said second groove having third and fourth facing walls; and
second elongated projections formed on said third and fourth facing walls and extending into said second groove, wherein said second groove and said second elongated projections function cooperatively to hold said identification card in said press fit engagement.

19. A device as claimed in claim 17 further comprising a notch formed in at least one of said edge ridge, said upper and lower walls, and said first and second side walls, said notch being configured to accommodate placement of a resilient band surrounding at least a portion of said writing tray to retain said fillable form on said writing tray.

20. A device as claimed in claim 17 wherein said card holder further includes a support member extending from said at least one wall and oriented substantially parallel to said writing tray, said support member being located between said groove and a back surface of said writing tray, said back surface opposing said planar surface.
